(19) United States
(12) Patent Application Publication
(10) Pub. No.: US 2017/0024649 A1
(43) Pub. Date: Jan. 26, 2017

(54) ANOMALY DETECTION SYSTEM AND METHOD FOR INDUSTRIAL ASSET

(71) Applicant: General Electric Company, Schenectady, NY (US)

(72) Inventors: Weizhong Yan, Clifton Park, NY (US); Lijie YU, Atlanta, GA (US)

(21) Appl. No.: 14/808,402

(22) Filed: Jul. 24, 2015

(51) Int. Cl. G06N 5/04; G06N 99/00

(52) U.S. Cl. CPC G06N 5/04; G06N 99/005

(57) ABSTRACT

Some embodiments are associated with a receipt, at a feature learning platform, of sensor data associated with normal operation of an industrial asset, the sensor data including values for a plurality of sensors over a period of time. The feature learning platform may extract a plurality of features via hierarchically deep learning, which may capture characteristics of normal operation of the industrial asset and provide the learned features to a classification modeling platform. The classification modeling platform may then create classification models utilizing the learned features, and the classification models may be executed to automatically identify a potential anomaly for an operating industrial asset.

### BACKGROUND

The invention relates generally to industrial assets and more particularly to systems and methods to provide anomaly detection for industrial assets.

An industrial asset may operate normally for substantial periods of time before a relative rare anomaly causes a malfunction of the asset. By way of example, combustors may be a critical component of gas turbine systems. Monitoring a combustor's health and, in particular, reliably detecting and/or predicting abnormal behaviors and incipient faults earlier, may be important to help ensure that gas turbines operate efficiently and help prevent costly unplanned maintenance and secondary damages to other turbine components. Using knowledge driven, manually created rules to infer an asset's health condition based on sensor data can be challenging because of, for example, low signal-to-noise ratio characteristics associated with such information. For example, a manually created rule detection process might typically result in a detection rate of approximately 55% for gas turbine combustors which may be below a desired detection rate.

It would therefore be desirable to facilitate a detection of anomalies in industrial asset operation, such as gas turbine combustor operation, in such a way so as to improve the efficiency and/or the accuracy of the process.

### BRIEF DESCRIPTION

According to some embodiments, there may be a receipt, at a feature learning platform, of sensor data associated with normal operation of an industrial asset, the sensor data including values for a plurality of sensors over a period of time. The feature learning platform may extract a plurality of features via hierarchically deep learning, which may capture characteristics of normal operation of the industrial asset and provide the learned features to a classification modeling platform. The classification modeling platform may then create classification models utilizing the learned features, and the classification models may be executed to automatically identify a potential anomaly for an operating industrial asset.

Other embodiments are associated with systems and/or computer-readable medium storing instructions to perform any of the methods described herein.

### DRAWINGS

FIG. 1A is a block diagram of a system that may be associated with any of the embodiments described herein.

FIG. 1B is a block diagram of a gas turbine system that may be associated with any of the embodiments described herein.

FIG. 2 is a flow chart of a method in accordance with some embodiments.

FIG. 3 is a block diagram of an overall system structure in accordance with some embodiments.

FIG. 4 is a blended approach using learned features and handcrafted features in accordance with some embodiments.

FIG. 5 illustrates a domain-driven feature according to some embodiments.

FIG. 6 is an example of a de-noising auto-encoder process in accordance with some embodiments.

FIG. 7 is an example of a restricted Boltzmann machine process in accordance with some embodiments.

FIG. 8 illustrates a set of learned features according to some embodiments.

FIG. 9 is an apparatus that may be provided in accordance with some embodiments.

FIG. 10 is a tabular view of a portion of a sensor database in accordance with some embodiments of the present invention.

### DETAILED DESCRIPTION

Some embodiments disclosed herein facilitate a detection of anomalies in an operation of an industrial asset, such as gas turbine combustor operation, in such a way so as to improve the efficiency and/or the accuracy of the process. Some embodiments are associated with systems and/or computer-readable medium that may help perform such a method.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

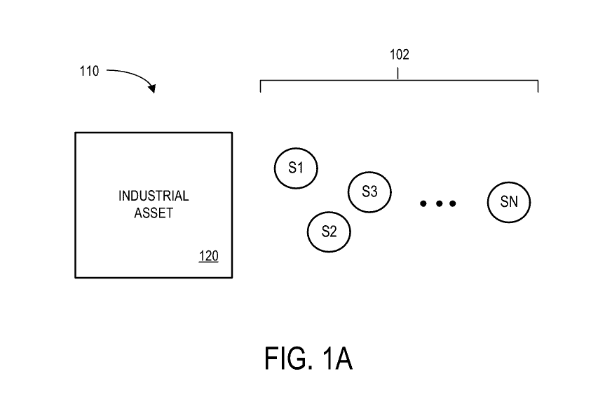

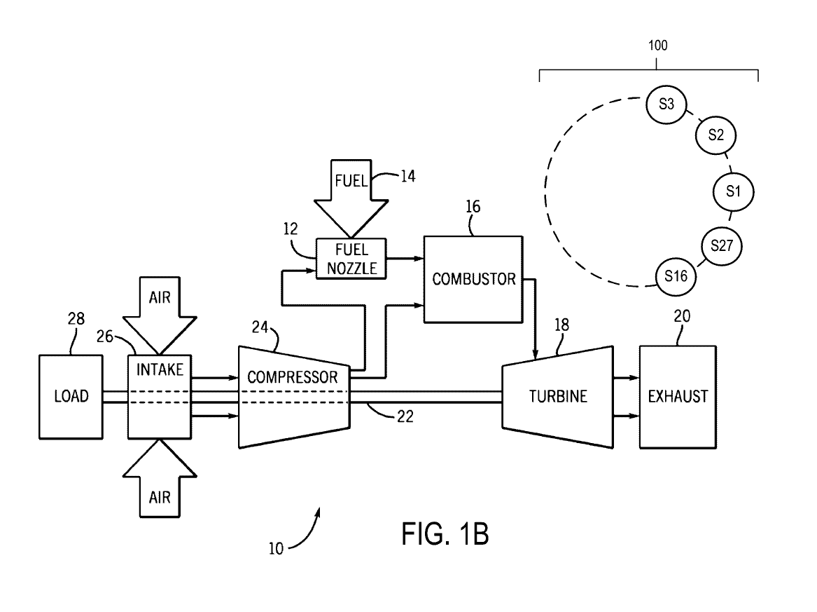

Some embodiments described herein may automatically facilitate a detection of anomalies in an operation of an industrial asset in such a way so as to improve the efficiency and/or the accuracy of the process. For example, FIG. 1A is a block diagram of a system 110 that may be associated with any of the embodiments described herein. The system includes an industrial asset 120 that may operate normally for substantial periods of time but occasionally, and relatively infrequently, experience an anomaly that results in a malfunction or other abnormal operation of the asset 120. According to some embodiments, a set of sensors 102 S1 through SN may monitor one or more characteristics of the asset 120 (e.g., temperature, vibration, noise, speed, etc.). The information from the sensors may, according to some embodiments described herein, be collected and used to facilitate detection and/or prediction of abnormal operation of an operating asset 120.

Note that embodiments described herein may be applicable to many different types of industrial assets. By way of example only, FIG. 1B is a block diagram of an embodiment of a turbine system 10. The turbine system 10 may use liquid or gas fuel, such as natural gas and/or a synthetic gas, to drive the turbine system 10. As depicted, one or more fuel nozzles 12 may intake a fuel supply 14, partially mix the fuel with air (e.g., an oxidant, such as O₂ and O₂ mixtures), and distribute the fuel 14 and air mixture into the combustor 16 where further mixing occurs between the fuel and air. A high-pressure-air-extraction manifold may couple to the combustor 16, guiding stable high-pressure air from the compressor to the fuel nozzle(s) 12. The stable high-pressure air enables purging of blank fuel nozzles/cartridges and/or to feed a pilot fuel nozzle/cartridge. The air-fuel mixture combusts in the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 is connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of turbine system 10.

According to some embodiment, a set of thermocouple temperature sensors 100 may be arranged in a circular pattern to measure the temperate of exhaust within the turbine 10. For example the set of sensors 100 may include 27 individual sensors that each take temperature measurements (e.g., once per second). According to some embodiments, this information may be captured and used to facilitate the detections of anomalies associated with the combustor 16.

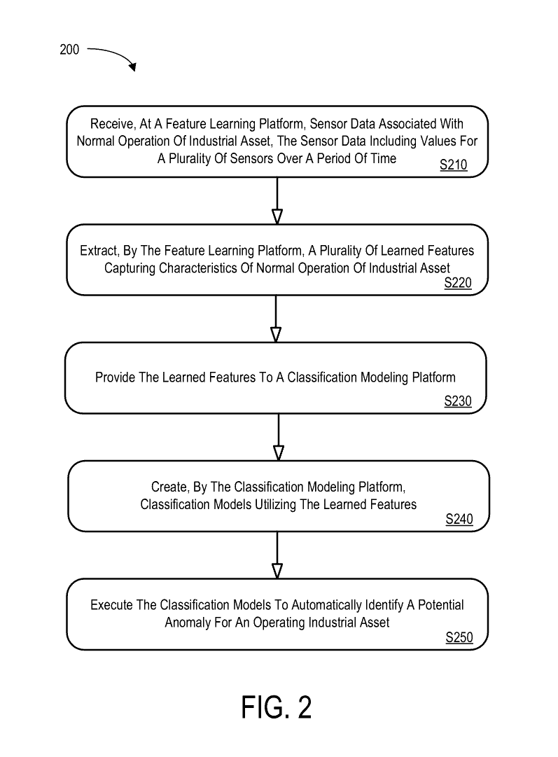

Consider, for example, FIG. 2 which is a flow chart of a method 200 associated with a method in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S210, a feature learning platform may receive sensor data associated with normal operation of an industrial asset. The sensor data may include, for example, values for a plurality of sensors over a period of time and may include thermocouple sensor measurements of exhaust temperatures of the a turbine combustors (e.g., as collected by the set of sensors 100 in FIG. 1B).

At S220, the feature learning platform may automatically extract a plurality of learned features capturing characteristics of normal operation of the industrial asset. Note that the learned features might be associated with a multi-level transformation or abstraction of the sensor data. For example, the learned features might be extracted using a deep learning process associated with an auto-encoder, a de-noising auto-encoder, and/or a restricted Boltzmann machine.

At S230, the learned features may be provided to a classification modeling platform. The classification modeling platform may then create one or more classification models utilizing the learned features at S240. At S250, the classification model or models may be executed to automatically identify a potential anomaly for an operating industrial asset.

In addition to data associated with normal operation of the industrial asset, in some embodiments the system may further access and/or utilize information associated with abnormal operation of the industrial asset (e.g., instances where an anomaly such as a failure had occurred). Note that there may but much more data available in connection with the normal operation of the asset as compared to information associated with failure events. As a result, weights might be assigned to feature vectors associated with abnormal operation and the weights may be relatively more substantial as compared to weights assigned to the feature vectors associated with normal operation. The feature vectors associated with both normal and abnormal operation, and associated weights, may then be used to facilitate creation of the classification models by the classification modeling platform.

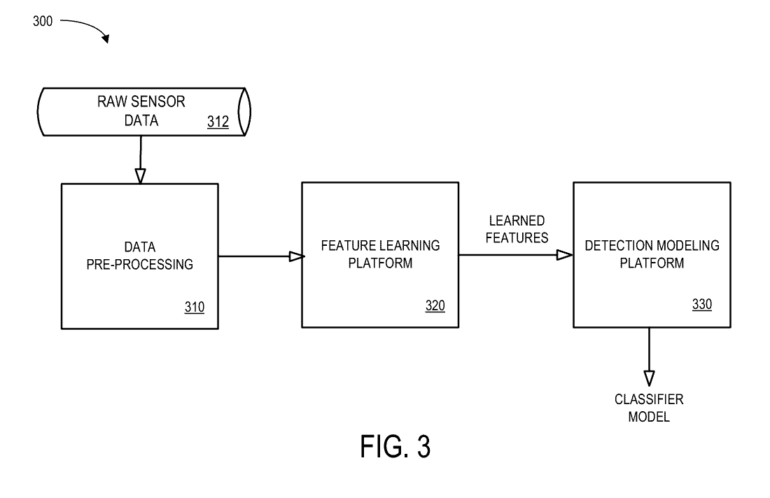

FIG. 3 is a block diagram of an overall system structure 300 in accordance with some embodiments. Initially, raw sensor data 312 may go through data pre-processing 310. The data pre-processing 310 might, for example, be adapted to perform: (i) irrelevant variable elimination, (ii) identification and treatment of outlier measurements, (iii) noise reduction, (iv) missing data treatment, and/or (v) segmentation. Information output from the data pre-processing 310 may be analyzed by a feature learning platform 320 to create learned features. These learned features may then be used by a detection modeling platform 330 to create one or more classifier models.

The feature learning platform 320 might, for example, apply deep neural networks for hierarchically learning salient features or signatures from a large number of unlabeled sensor data (unsupervised learning). Such learned features might capture complex relations across the thermocouple measurements and the underlying system's behavior, which may lead to more accurate and robust anomaly detection.

The detection modeling platform 330 might, for example, treat anomaly detection problems as a one-class classification problem or a two-class classification problem. For one-class classification, detection modeling platform 330 might only use so-called normal data and the model may essentially find and represent normality boundary and normality behavior and structure. Any testing points that are determined statistically to not belong to the normality described by the model may be deemed “abnormal.” In this one-class classification setting, the classification models may be built with no or a few abnormal samples. For two-class classification modeling, the detection modeling platform 330 might need both normal and abnormal samples. Since most real-world application, such as aircraft engine application, will include few abnormal samples (faulty events) and a large majority of samples will be normal. As a result, the system may address the so-called “unbalanced data” issues that will be faced in classification model building. Some embodiments described herein may use an extreme learning machine (a special type of feed-forward neural network), as the classifier and address the unbalanced data issue by giving different weights to normal and abnormal samples, respectively. Note that an extreme learning machine is only one example of a process that might be associated with a classifier, and any of the embodiments described herein might be associated with any other type of classifier, including a neural network, a support vector machine, and/or a random forest

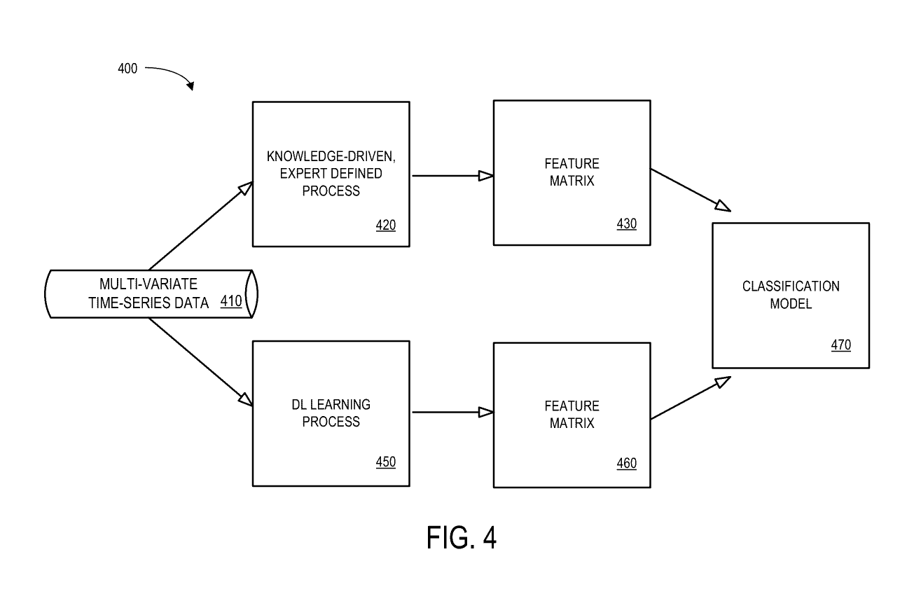

FIG. 3 is a high level approach that utilizes the creation of automatically learned features (as compared to the typically manually generated rues). FIG. 4 is a blended approach 400 that uses both automatically learned features and expert defined features in accordance with some embodiments. In this example, multi-variate time-series data 410 may go through a knowledge-driven, expert define 430 to create a feature matrix 440. The multi-variate time-series data 410 may also go through a DL learning process 450 to create another feature matrix 460. Both feature matrixes 430, 440 may then be blended and used to create a classification model 470 that may be more accurate (e.g., increased detection rate and/or fewer false alarms) as compared to using either technique alone. That is, features defined by domain or engineering experts may be integrated with the automatically generated model, if these experts-specified features are available. The expert defined features might be associated with, for example: (i) a maximum, (ii) a minimum, (iii) a mean, (iv) a standard, (v) a median, (vi) a difference between positive and negative values, (vii) a zero-crossing, (viii) kurtosis, (ix) skewness, (x) a maximum of a multi-point sum, and/or (xi) a minimum of a multi-point sum; of the sensor measurements.

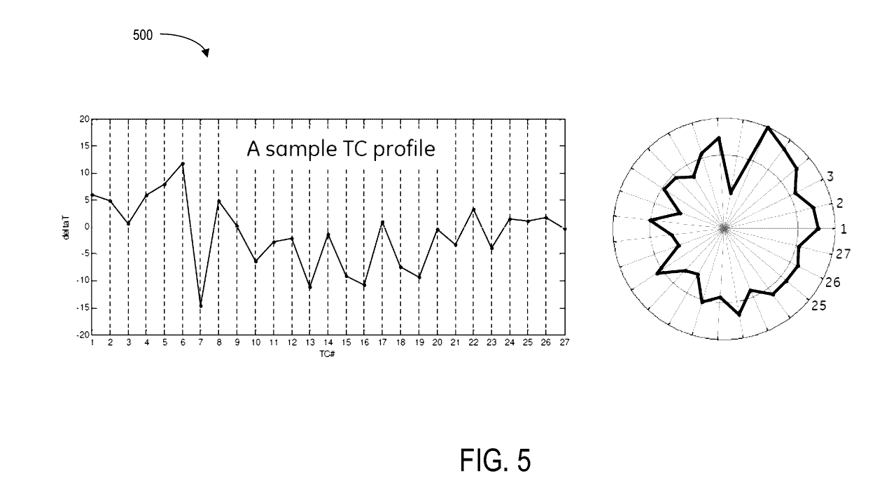

FIG. 5 illustrates a domain-driven feature 500 according to some embodiments. The feature 500 might be associated with, for example, an array of 27 thermal sensors, including three months of data collected by those sensors once per minute. In addition, information about 4 anomaly events might be available (e.g., including 30 minutes of sensor data prior to the anomaly event). As a result there might be 13,791×27 normal data points for feature learning and 300×27 abnormal data points. The feature 400 is illustrated both as a typical x-y graph (of delta from average values) and as a graph illustrating the circular configuration of the physical sensors.

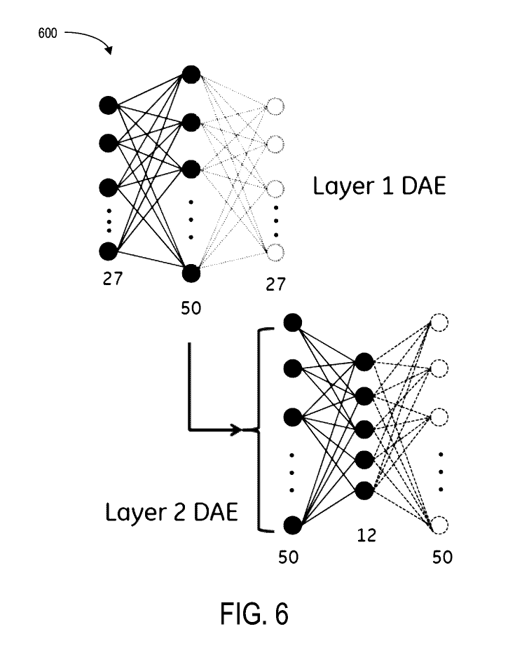

FIG. 6 is an example of a de-noising auto-encoder process 600 in accordance with some embodiments. The process 600 starts with 50 potentially relevant features and uses a two layer de-noising auto-encoder approach to generate a set of, for example, 12 relevant features. The process 600 may utilize deep learning to find the features (i.e., signatures) using neural networks. For example, the auto-encoder may learn a compressed, distributed representation (encoding) for the set of data using a feedforward, non-recurrent neural net with an input layer, an output layer and one or more hidden layers connecting them

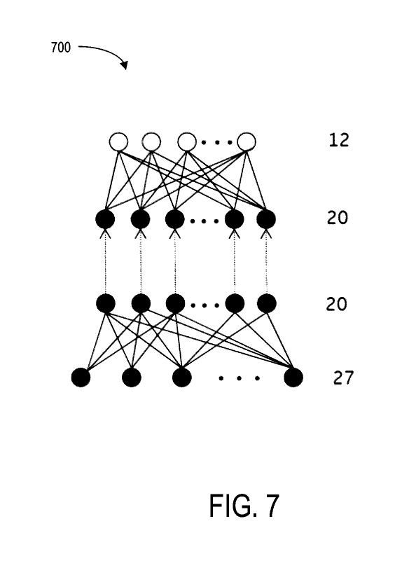

FIG. 7 is an example of a restricted Boltzmann machine process 700 in accordance with some embodiments. The process 700 starts with 27 potentially relevant features and uses a restricted Boltzmann machine approach to generate a set of, for example, 12 relevant features. According to some embodiments, the process prevents intra-layer connections between hidden units, and after training one machine, the activities of the hidden units may be treated as data for training a higher-level machine. As each new layer is added, the overall generative model created by the process 700 may improve.

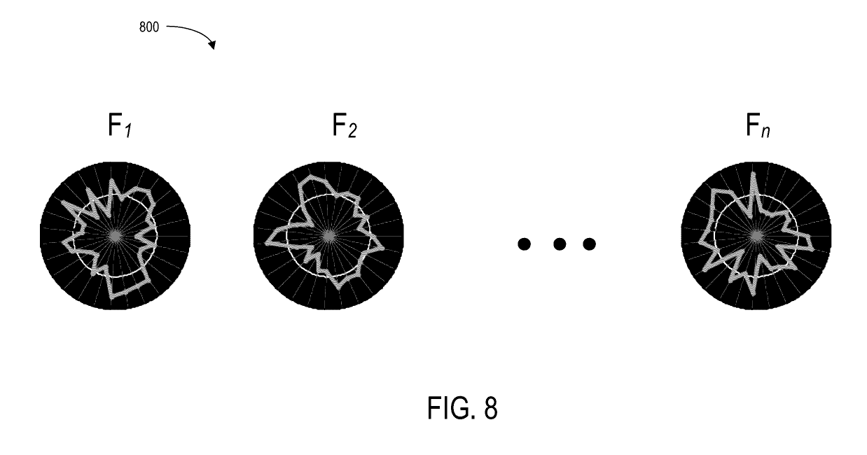

FIG. 8 illustrates a set of learned features 800 according to some embodiments. In particular, features 800 F₁ through Fₙ may have been automatically created (e.g., using the techniques described in connection with FIGS. 6 and/or 7). Thus, some embodiments described herein may improve the detection rate of combustors by intelligently identifying important signatures or features from the thermocouple measurements and by applying advanced machine learning technologies. More specifically, some embodiments may hierarchically learn representative features from big, unlabeled raw sensor measurements.

Note that traditional approaches to industrial asset anomaly, such as combustor anomaly, detection typically rely on a set of decision rules that are applied to the raw sensor measurements. Those decision rules and their associated rule constants are empirically determined by domain or engineering experts (a knowledge-driven approach, which is not only a manual and labor intensive process, but also may have insufficient detection performance, including detection rates and false alarms). One reason for low detection performance associated with the traditional approaches is that the decision logic was executed either directly on sensor measurements or on the results of some simple algorithmic operations (e.g., addition, subtraction, and ratio) of the sensor measurements, or some combination of these two, all of which might not fully capture the underlying system behavior and structure. Another reason for low detection performance in traditional approaches is that simple decision rules (simple and transparent) might not be able to define a complex (e.g., highly non-linear) decision boundary.

In contrast, some embodiments described herein provide a combustor anomaly detection scheme that is based on more advanced machine learning technologies. Some embodiments may first finds features/signatures that best capture among-variable relations and best represent the underlying system behaviors by hierarchically learning features from unlabeled sensor measurements. The system may then apply advanced modeling techniques (e.g., using an extreme learning machine) on the learned features. Such an approach may provide an improved anomaly detection capability for gas turbine combustor systems. In addition, with the feature learning scheme, the system may automate anomaly detection design process, which may reduce the need of engineering knowledge—as well as the laborious manual efforts—in designing and implementing anomaly detection solutions.

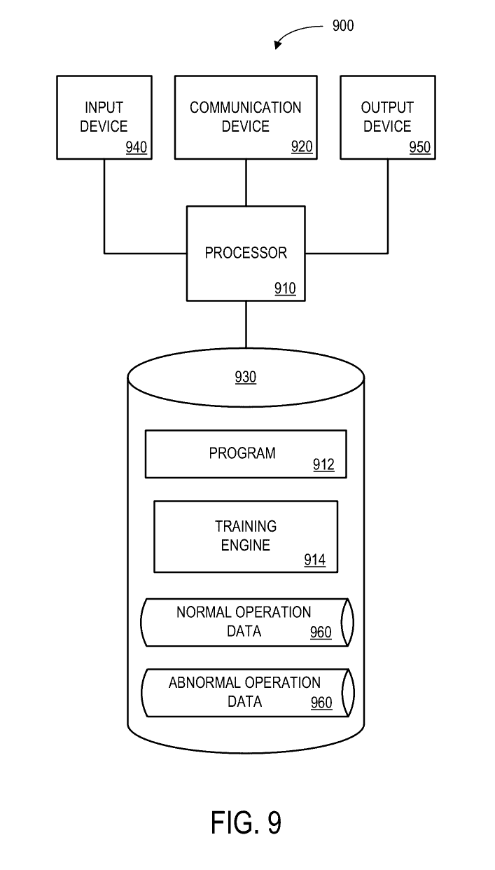

The embodiments described herein may be implemented using any number of different hardware configurations. For example, FIG. 9 illustrates an apparatus 900 that may be, for example, associated with the system 110 of FIG. 1A or the system 10 of FIG. 1B. The apparatus 900 comprises a processor 910, such as one or more commercially available Central Processing Units (CPUs) in the form of one-chip microprocessors, coupled to a communication device 920 configured to communicate via a communication network (not shown in FIG. 9). The apparatus 900 further includes an input device 940 (e.g., a mouse and/or keyboard to enter information about industrial asset operation and anomalies) and an output device 950 (e.g., a computer monitor to output warning and reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a training engine 914 (e.g., associated with a training process) for controlling the processor 910. The processor 910 performs instructions of the programs 912, 914, and thereby operates in accordance with any of the embodiments described herein. For example, the processor 910 might receive sensor data associated with normal operation of an industrial asset, the sensor data including values for a plurality of sensors over a period of time. The processor 910 may extract a plurality of learned features capturing characteristics of normal operation of industrial asset and provide the learned features to a classification modeling platform. The processor 910 and/or the classification modeling platform may then create one or more classification models utilizing the learned features, and the classification model or models may be executed to automatically identify a potential anomaly for an operating industrial asset.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

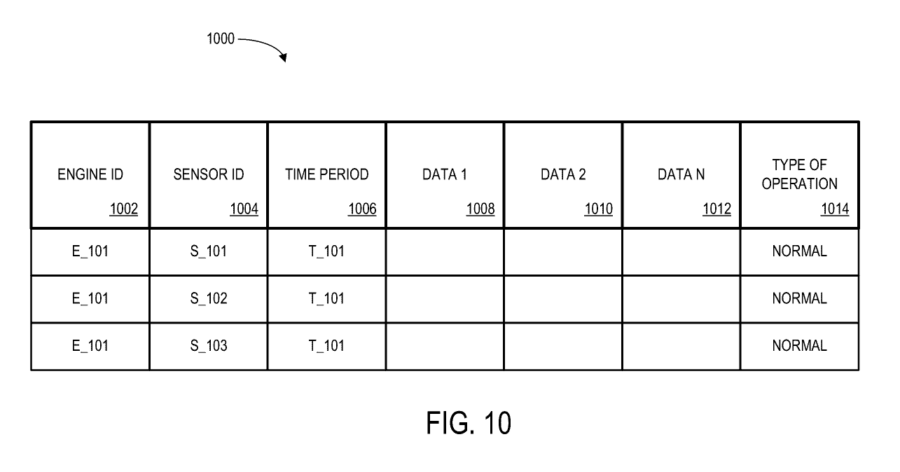

As shown in FIG. 9, the storage device 930 also stores normal operation data 960 and abnormal operation data 970 associated with gas turbine combustors. One example of a database 1000 that may be used in connection with the detection apparatus 900 will now be described in detail with respect to FIG. 10. The illustration and accompanying descriptions of the database presented herein is exemplary, and any number of other database arrangements could be employed besides those suggested by the figures.

FIG. 10 is a tabular view of a portion of a database 1000 in accordance with some embodiments of the present invention. The table includes entries associated with operation of a gas turbine combustor. The table also defines fields 1002, 1004, 1006, 1008, 1010, 1012, 1014 for each of the entries. The fields specify: an engine ID 1002, a sensor ID 1004, a time period 1006, data 1 1008, data 2 1010, data N 1012, and type of operation 1014. The information in the database 900 may be periodically created and updated based on information collection during operation of remote turbines.

The engine ID 1002 might be a unique alphanumeric code identifying 1002 a gas turbine engine and the sensor ID 1004 might identify a thermocouple sensor that created the measurement at the specific time period 1006. The database includes data point 1 through N 1008, 1010, 1012, but embodiments may be associated with any number of data points. Finally, the database 1000 may include an indication 1014 as to type of operation of the turbine 1014 (e.g., whether the data is associated with normal or abnormal operation of the combustor).

Thus, some embodiments described herein may identify more salient signatures or features that best capture cross-variable relations and best represent the underlying behavior and structure of the system, which may lead to better anomaly detection performance. Moreover, embodiments may automatically create more accurate and robust detection performance and use unsupervised learning (which may help address a lack of labeled samples in real world applications). Still further, embodiments described herein may be data-driven, i.e., domain knowledge agnostic, but at the same time, may be able to easily incorporate domain knowledge. In addition, some embodiments may handle unbalanced data to address the fact that positive (i.e., faulty) samples may be relatively sparse in real-world applications.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with turbine combustors used for airplanes and/or generators, although embodiments may be used in connection other any other type of industrial asset.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A computer-implemented method associated with anomaly detection of an industrial asset, comprising:
receiving, at a feature learning platform, sensor data associated with normal operation of the industrial asset, the sensor data including values for a plurality of sensors over a period of time;
extracting, by the feature learning platform, a plurality of learned features capturing characteristics of normal operation of the industrial asset;
providing the learned features to a classification modeling platform; and
creating, by the classification modeling platform, classification models utilizing the learned features.

2. The method of claim 1, further comprising:
executing the classification model to automatically identify a potential anomaly for an operating industrial asset.

3. The method of claim 1, wherein the industrial asset comprises gas turbine combustors and the sensor data associated with normal operation of gas turbine combustors comprises thermocouple sensor measurements of exhaust temperatures of the gas turbine combustors.

4. The method of claim 1, wherein the sensor data is received from a data pre-processing platform adapted to perform at least one of: (i) irrelevant variable elimination, (ii) identification and treatment of outlier measurements, (iii) noise reduction, (iv) missing data treatment, and (v) segmentation.

5. The method of claim 1, wherein the learned features are associated with a multi-level transformation or abstraction of the sensor data.

6. The method of claim 5, wherein the learned features are extracted using a deep learning process associated with at least one of: (i) an auto-encoder, (ii) a de-noising auto-encoder, and (iii) a restricted Boltzmann machine.

7. The method of claim 6, wherein the classification models are associated with at least one of: (i) an extreme learning machine, (ii) a neural network, (iii) a support vector machine, and (iv) a random forest.

8. The method of claim 1, further comprising:
receiving, at the feature learning platform, sensor data associated with abnormal operation of the industrial asset;
assigning weights to feature vectors associated with abnormal operation relatively more substantial as compared to weights assigned to feature vectors associated with normal operation; and
using the feature vectors associated with both normal and abnormal operation, and associated weights, to facilitate creation of the classification models by the classification modeling platform.

9. The method of claim 1, further comprising:
receiving information about a set of expert defined features; and
blending the set of expert defined features to facilitate creation of the classification models by the classification modeling platform.

10. The method of claim 9, wherein at least one of the expert defined features is associated with: (i) a maximum, (ii) a minimum, (iii) a mean, (iv) a standard, (v) a median, (vi) a difference between positive and negative values, (vii) a zero-crossing, (viii) kurtosis, (ix) skewness, (x) a maximum of a multi-point sum, and (xi) a minimum of a multi-point sum; of the sensor measurements.

11. A non-transitory, computer-readable medium storing instructions that, when executed by a computer processor, cause the computer processor to perform a method associated with anomaly detection of an industrial asset, the method comprising:
receiving, at a feature learning platform, sensor data associated with normal operation of the industrial asset, the sensor data including values for a plurality of sensors over a period of time;
extracting, by the feature learning platform, a plurality of learned features capturing characteristics of normal operation of the industrial asset;
providing the learned features to a classification modeling platform;
creating, by the classification modeling platform, classification models utilizing the learned features; and
executing the classification model to automatically identify a potential anomaly for an operating industrial asset.

12. The medium of claim 11, wherein the industrial asset comprises gas turbine combustors and the sensor data associated with normal operation of gas turbine combustors comprises thermocouple sensor measurements of exhaust temperatures of the gas turbine combustors.

13. The medium of claim 11, wherein the learned features are associated with a multi-level transformation or abstraction of the sensor data.

14. The medium of claim 13, wherein the learned features are extracted using a deep learning process associated with at least one of: (i) an auto-encoder, (ii) a de-noising auto-encoder, and (iii) a restricted Boltzmann machine.

15. The medium of claim 11, wherein the method further comprises:
receiving, at the feature learning platform, sensor data associated with abnormal operation of the industrial asset;
assigning weights to feature vectors associated with abnormal operation relatively more substantial as compared to weights assigned to feature vectors associated with normal operation; and
using the feature vectors associated with both normal and abnormal operation, and associated weights, to facilitate creation of the classification models by the classification modeling platform.

16. The medium of claim 11, wherein the method further comprises:
receiving information about a set of expert defined features; and
blending the expert defined features to facilitate creation of the classification models by the classification modeling platform.

17. A system, comprising:
a storage device to store a set of sensor data associated with normal operation of gas turbine combustors, the sensor data including values for a plurality of sensors over a period of time;
a feature learning platform computer system coupled to the storage device to: (i) receive the sensor data, and (ii) extract a plurality of learned features capturing characteristics of normal operation of gas turbine combustors; and
a classification modeling platform computer system to: (i) create a classification model utilizing the learned features, and (ii) arrange for an execution of the classification model to automatically identify a potential anomaly for an operating gas turbine combustor.

18. The system of claim 17, wherein the sensor data associated with normal operation of gas turbine combustors comprises thermocouple sensor measurements of exhaust temperatures of the gas turbine combustors.

19. The system of claim 18, wherein the learned features are associated with a multi-level transformation or abstraction of the sensor data.

20. The system of claim 19, wherein the learned features are extracted using a deep learning process associated with at least one of: (i) an auto-encoder, (ii) a de-noising auto-encoder, and (iii) a restricted Boltzmann machine.
